(19) United States
(12) Patent Application Publication
(10) Pub. No.: US 2006/0227189 A1
(43) Pub. Date: Oct. 12, 2006

(54) Ink filling structure

(76) Inventor: Ta-Chiun Kuan, Sinfong Township (TW)

Correspondence Address: LOWE HAUPTMAN BERNER, LLP, 1700 DIAGONAL ROAD, SUITE 300, ALEXANDRIA, VA, 22314, US

(21) Appl. No.: 11/371,221

(22) Filed: Mar. 9, 2006

(30) Foreign Application Priority Data
Apr. 11, 2005 (TW) 094111282

(51) Int. Cl. B41J 2/175

(52) U.S. Cl. 347/86

(57) ABSTRACT

An ink filling structure includes a case, a guiding element received in the case for controlling flowage of the ink, a washer positioned between the guiding element and the case, and an elastic element connecting with the guiding element for providing the guiding element with an elastic force to push the guiding element to a predetermined position. When the guiding element is located at the predetermined position, the guiding element prevents the ink from reflowing; while the guiding element is located at other positions, the ink can reflow.

### BACKGROUND OF THE INVENTION

1. Field of the Invention

The present invention relates to an ink filling structure used in an ink cassette, especially to an ink filling structure for injecting the ink into the ink cassette and preventing the ink from overflowing.

2. Description of the Related Arts

A conventional ink-jet printer uses an ink cassette to jet needed ink in sequence for achieving the purpose of printing.

The price of an ink cassette provided by a traditional ink-jet printer manufacturer is generally high, which causes the users to choose relatively cheaper ink cassettes provided by other manufacturers for economizing cost of ink-use. The cheaper ink cassette provided by other manufacturers can be compatible with different type of ink cassette.

However, an ink cassette used in an ink-jet printer, such as a heat-inductive ink-jet printer manufactured by Hewlett-Packard, or a hot-air-bubble ink-jet printer provided by CANON, generally cooperates with an interactional sprayer. While the user replaces the ink cassette by a cheaper one, the sprayer is synchronously replaced. Thus, the cost is still high.

Base on the problem mentioned above, the user often chooses an ink-jet printer having an independent ink cassette and an independent sprayer. For example, a user will choose an ink-jet printer manufactured by EPSON and use an ink cassette provided by another manufacturer for economizing the cost. While the user fills the ink cassette, an acerate injector is used to inject the ink into the cassette. However, the injecting process is not easy to be controlled, which can cause the ink to overflow or to be dried.

Accordingly, a new ink filling structure is desired.

### SUMMARY OF THE INVENTION

A major object of the present invention is to provide an ink filling structure for injecting ink into an ink cassette and preventing the ink from overflowing.

Another object of the present invention is to provide an ink filling structure that can be used in different types of ink cassettes for enabling the ink cassette to filling ink.

According to the above-mentioned objects, an ink filling structure is accordingly provided by the present invention. The ink filling structure includes a case, a guiding element received in the case for controlling flowage of the ink, a washer positioned between the guiding element and the case, and an elastic element connecting with the guiding element for providing the guiding element with an elastic force to push the guiding element to a predetermined position. When the guiding element is located at the predetermined position, the guiding element prevents the ink from reflowing; while the guiding element is located at other positions, the ink can reflow.

According to the above-mentioned invention, the guiding element further includes a top portion, a guiding portion and a stopping portion. When the guiding element is at the predetermined position, the stopping portion abuts against one end of the washer for preventing the ink from reflowing.

According to the above-mentioned invention, the guiding element further includes an extending portion. The guiding element can move along an extending direction of the extending portion back and forth.

According to the above-mentioned invention, the extending portion is sleeved by the elastic element.

According to the above-mentioned invention, while the top portion of the guiding element is forced, the guiding element moves away from the predetermined position, and the ink can reflow via a guiding hole defined in the guiding portion and the stopping portion.

According to the above-mentioned invention, the top portion of the guiding element is force by an ink filling container. When the guiding element is not at the predetermined position, ink in the ink filling container can reflow via the guiding holes in the guiding portion and the stopping portion.

According to the above-mentioned invention, the top portion is forced by a communicating member. When the guiding element is not at the predetermined position, outer air can reflow via a ventilative hole defined in the communicating member and the guiding holes.

According to the above-mentioned invention, cross-sectional shapes of the top portion and the guiding portion are same to that of an inner ring of the washer. The cross-sectional shape of the top portion is complementary to that of the guiding portion. The shape of the top portion is selected from cross, line, circle with a plurality of cuts, or complementary shapes of the above.

According to the above-mentioned invention, the washer abuts against an inner surface of the case, and the guiding element can move at the inner side of the washer, back and forth.

According to the above-mentioned invention, the elastic element is a spring or an elastic pad.

According to the above-mentioned invention, the guiding hole includes a filtering net therein.

According to the above-mentioned invention, an ink cassette is provided by the present invention. The ink cassette includes a box, an ink outputting element located at a given position of the box, for providing ink, and a first ink filling structure located at another position of the box. The first ink filling structure is the same as the above-described ink filling structure.

According to the above-mentioned invention, the ink cassette further includes a second ink filling structure. The second ink filling structure is same to the first one.

According to the above-mentioned invention, the ink outputting element is selected from the following groups: a piezoelectric sprayer, a hot-air-bubble sprayer, an ink outputting hole, a third ink filling structure. The third ink filling structure is same to the first one.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

The present invention will become more apparent from the following detailed description when taken in conjunction with the accompanying drawings, in which:

### BRIEF DESCRIPTION OF THE DRAWINGS

FIG. 1 is a cross-sectional view of an ink filling structure used in an ink cassette in accordance with a first preferred embodiment of the present invention;

FIG. 2A is a cross-sectional view of the ink filling structure in a state of preventing ink reflow;

FIG. 2B is a cross-sectional view of the ink filling structure in a state of allowing ink reflow by an ink filling container;

FIG. 2C is a cross-sectional view of the ink filling structure in a state of allowing ink reflow by a communicating member;

FIG. 3A is an isometric view of a guiding element of the ink filling structure;

FIG. 3B is a top view of the guiding element in FIG. 3A;

FIG. 3C is an isometric view of another guiding element of the ink filling structure;

FIG. 3D is a top view of the guiding element of FIG. 3C;

FIG. 3E is an isometric view of a third guiding element of the ink filling structure;

FIG. 3F is a top view of the guiding element of FIG. 3E;

FIG. 3G is an isometric view of a fourth guiding element of the ink filling structure;

FIG. 3H is a top view of the guiding element of FIG. 3G;

FIG. 4A is an isometric view of a communicating element of the ink filling structure;

FIG. 4B is a top view of the communicating element of FIG. 4A;

FIG. 5 is a cross-sectional view of an ink filling structure used in an ink cassette in accordance with a second preferred embodiment of the present invention;

FIG. 6 is a cross-sectional view of an ink filling structure used in an ink cassette in accordance with a third preferred embodiment of the present invention; and

FIG. 7 is a cross-sectional view of an ink filling structure used in an ink cassette in accordance with a fourth preferred embodiment of the present invention.

### DESCRIPTION OF PREFERRED EMBODIMENT

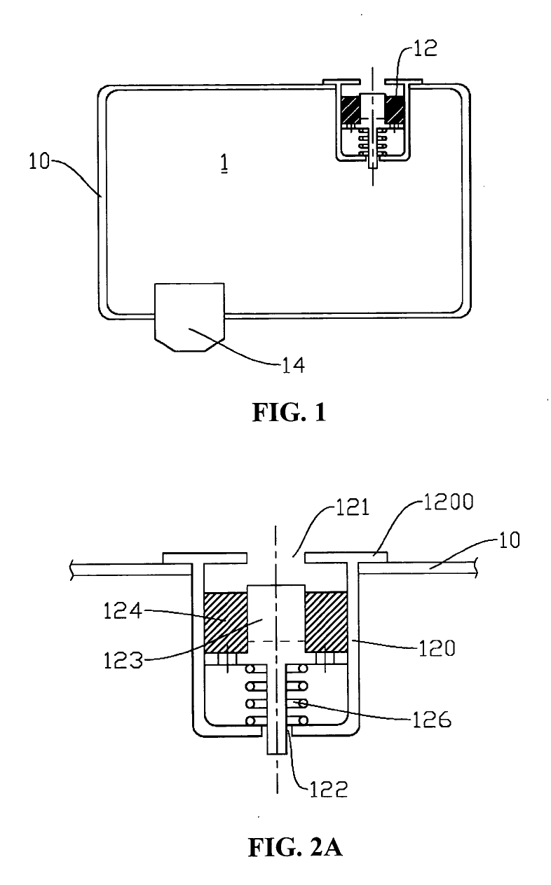

Reference will now be made to the drawings to describe the present invention in detail. FIG. 1 is a cross-sectional view of an ink filling structure 12 used in an ink cassette 1 in accordance with a first preferred embodiment of the present invention. As illustrated, the ink cassette 1 includes a box 10, an ink outputting element 14 and an ink filling structure 12. The ink filling structure 12 can be directly embedded in the box for filling ink in the ink cassette 1. The ink outputting element 14 is a piezoelectric sprayer, a hot-air-bubble sprayer, or an ink providing hole. The ink outputting element 14 is used in an ink-jet printer (not shown) to jet ink in sequence for printing. Operating method and detailed structures of above-mentioned ink filling structure 12 will be described in detail.

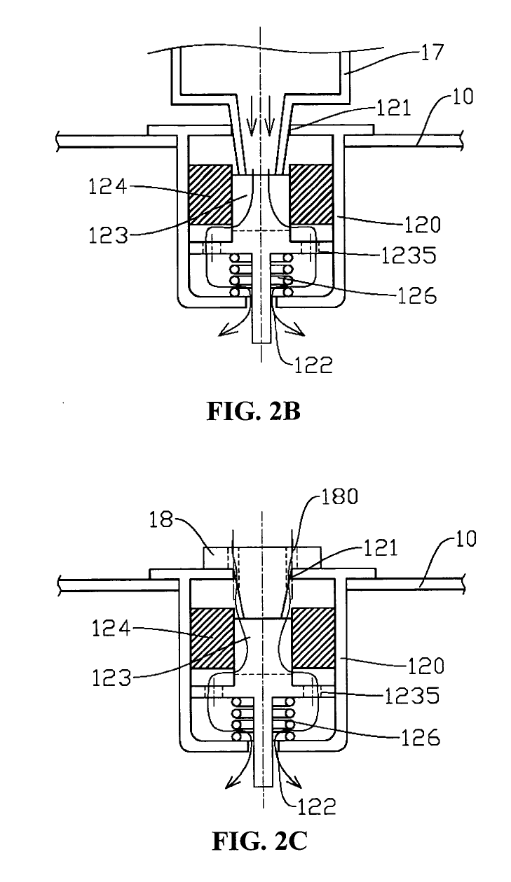

Referring to FIG. 2A, the ink filling structure 12 includes a case 120, a guiding element 123, a washer 124, and an elastic element 126. The case defines a space for receiving all the needed elements of the ink filling structure 12. An upper portion 1200 of the case 120 can be assembled with the box 10, which enables the ink filling structure 12 to be compatible with different types of ink cassette 1. The guiding element 123 is positioned in the case 120 for control the reflowing of the ink. The washer 124 sleeves between the guiding element 123 and the case 120, and an outer portion of the washer is firmly abut against an inner surface of the case 120. The guiding element 123 can move relative to the washer 124 back and forth in an inner side of the washer 124. The elastic element 126 connects with one end of the guiding element 123 for providing the guiding element 123 with an elastic force to push the guiding element 123 to a predetermined position. In a better mode, the elastic element 126 is a spring, an elastic pad, or any elastic member.

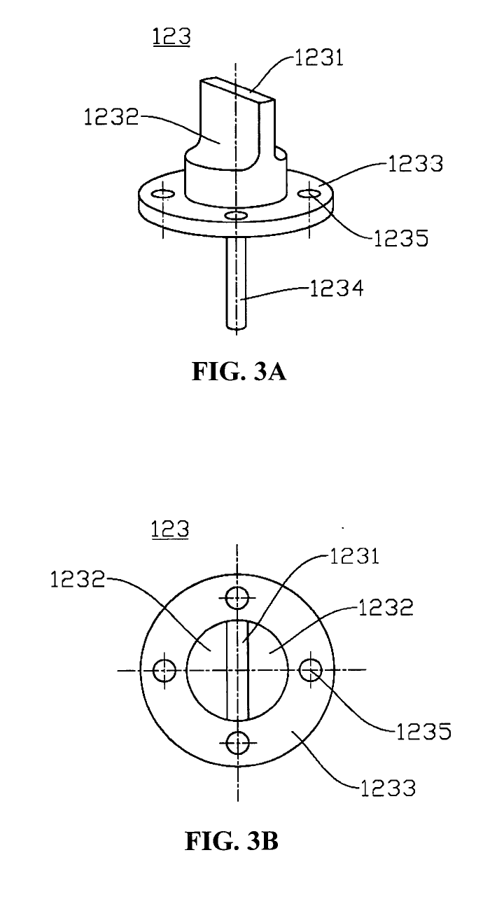

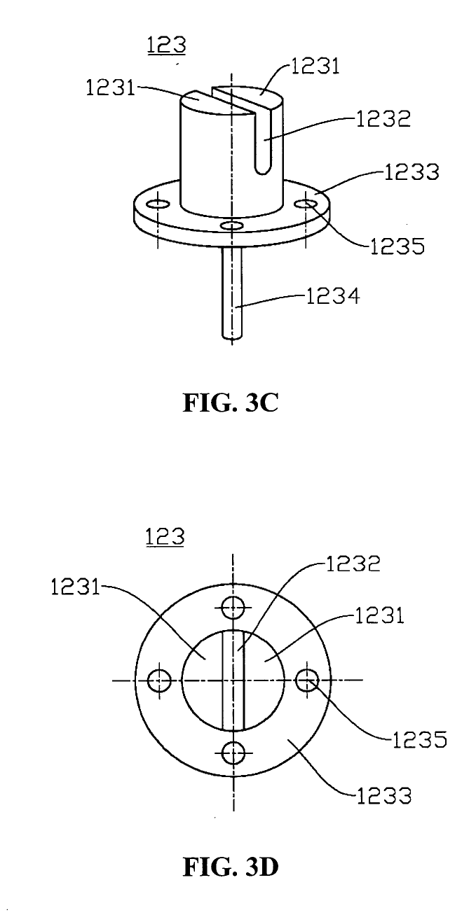

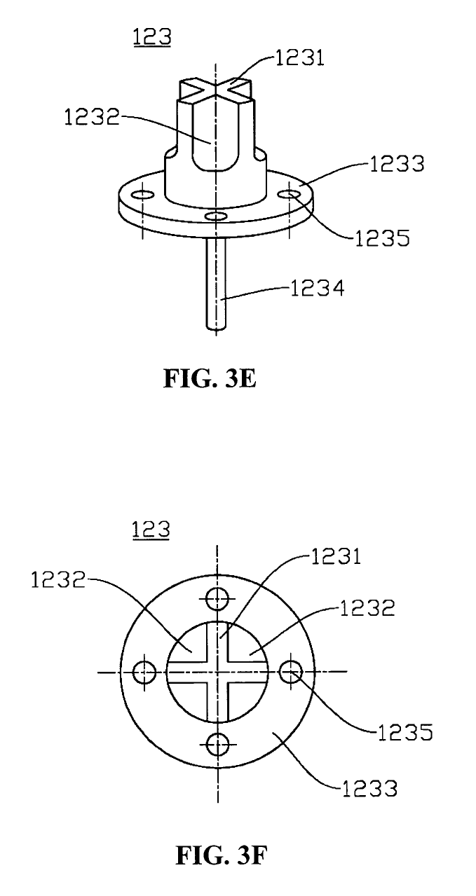

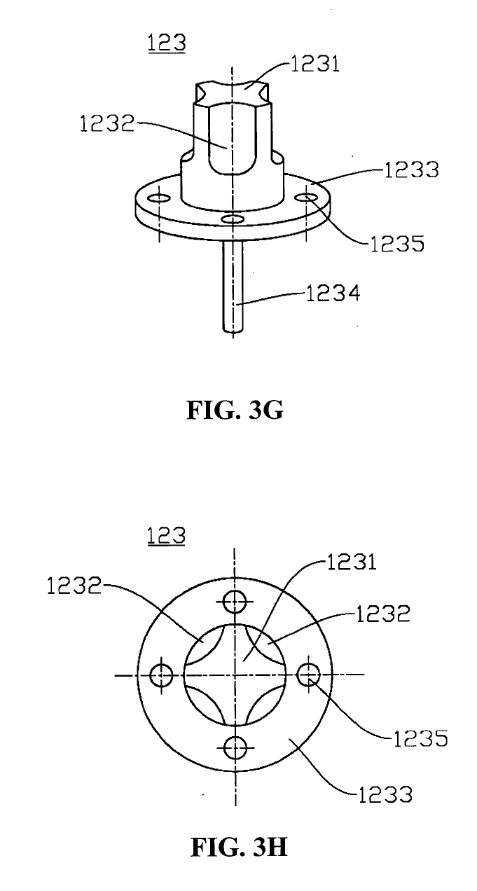

Referring to FIG. 3A-3B, the guiding element 123 will be described in detail. FIG. 3A is an isometric view of the guiding element 123m, and FIG. 3B is a top view of FIG. 3A. As illustrated, the guiding element 123 includes a top portion 1231, a guiding portion 1232, a stopping portion 1233 and a extending portion 1234. The top portion 1231 faces to an ink inputting port 121 of the ink filling structure 12, and the extending portion 1234 faces to an outputting port 122. The extending portion 1234 is sleeved by the elastic element 126. One end of the elastic element 126 connects to an inner side of the case 120, and another end connects to the stopping portion 1233. The guiding element 123 is sleeved by the washer 124. Therefore, the elastic force will push the guiding element 123 to the predetermined position along an extending direction of the extending portion 1234. As illustrated in FIG. 2A, when the stopping portion 1233 abuts against the washer 124, no channel is provided for ink reflowing. As a result, the ink can not enter the ink cassette 1, and the purpose of preventing overflowing is accordingly achieved. Referring to FIG. 2B, filling type ink is generally contained in an ink filling container 17. When the ink filling container 17 is actuated into the ink filling structure 12 from the ink inputting port 121, the ink filling container 17 presses on the top portion 1231 of the guiding element 123 and pushes the guiding element 123 to move toward the ink outputting port 122. The guiding element 123 is accordingly away from the predetermined position. As shown in FIG. 2B, the stopping portion 1233 of the guiding element 123 moves away from the washer 124. In this embodiment, the top portion 1231 is line-shaped, and the cross-sectional shape of the guiding portion 1232 is complementary to the top portion 1231. Cross-sectional shapes of the top portion 1231 and the guiding portion 1232 are similar to that of an inner ring of the washer 124. The stopping portion 1233 defines at least one guiding hole 1235 therein. The ink from the ink filling container 17 can reflow into the ink filling structure 12 via the ink inputting port 121, and can then reflow through the guiding portion 1232 and the guiding hole 1235 successively. Finally, the ink enters the ink cassette 1. The reflowing path is illustrated by curves with direction arrows in FIG. 2B. The function of filling ink is thus achieved. Further, the guiding hole 1235 can include a filtering net (not shown) therein for filter the ink reflowing through the guiding hole 1235. After the ink filling process completed, the ink filling container 17 is removed from the ink filling structure 12, and the guiding element 123 moves back to the predetermined position by the elastic force provided by the elastic element 126.

According to the description above, several embodiments of the guiding element 123 can be actualized. FIG. 3C shows another embodiment of the guiding element 123, and FIG. 3D is a top view of FIG. 3C. As illustrated, the guiding element 123 includes a top portion 1231, a guiding portion 1232, a stopping portion 1233 and an extending portion 1234. Position and function of each element is the same to those described in the former embodiment. What is different from the former embodiment is that the cross-sectional shape of the guiding portion 1231 is line-shaped. At the same time, the shape of the top portion 1231 is complementary with that of the guiding portion 1232. Cross-sectional shapes of the top portion 1231 and the guiding portion are identical to that of the inner ring of the washer 123. Thus, when the ink filling container 17 pushes the top portion 1231, the guiding portion 1232 will achieve the function of allowing ink to reflow to the stopping portion 1233. Similarly, FIGS. 3E-3F show another embodiment of the guiding element 123. FIG. 3E is an isometric view of the guiding element 123, and FIG. 3F is a top view of FIG. 3E. The top portion 1231 of the guiding element 123 of this embodiment is cross-shaped, and the guiding portion 1232 is configured to be complementary with the top portion 1231. Cross-sectional shapes of the top portion 1231 and the guiding portion are identical to that of the inner ring of the washer 123. Thus, when the ink filling container 17 pushes the top portion 1231, the guiding portion 1232 will achieve the function of allowing ink to reflow to the stopping portion 1233. Further, FIGS. 3G-3H show another embodiment of the guiding element 123. FIG. 3G is an isometric view of the guiding element 123, and FIG. 3H is a top view of FIG. 3G. The top portion 1231 of the guiding element 123 of this embodiment is a circular shape with a plurality of cuts, and the guiding portion 1232 is configured to be complementary with the top portion 1231. Cross-sectional shapes of the top portion 1231 and the guiding portion are identical to that of the inner ring of the washer 123. Thus, when the ink filling container 17 pushes the top portion 1231, the guiding portion 1232 will achieve the function of allowing ink to reflow to the stopping portion 1233. It's noted that configurations of the top portion 1231 and the guiding portion 1232 are not limited within the embodiments described above. As long as the top portion 1231 and the guiding portion 1232 are sleeved in the inner ring of the washer 124, and the shapes thereof are complementary, the function of allowing ink to reflow will be achieved when the guiding element 123 is not at the predetermined position.

FIG. 5 is a cross-sectional view of an ink filling structure used in an ink cassette in accordance with a second preferred embodiment of the present invention. The ink cassette 2 includes a box 20, a first ink filling structure 22 and a second ink filling structure 24. The first and second ink filling structures 22, 24 are substantially similar to those described above. However, the second ink filling structure 24 can serve as an ink outputting element. Certainly, a corresponding printer (not shown) should be provided with a sprayer (not shown), and with a protruded guiding member to protrude into the second ink filling structure 24, which can actuate the second ink filling structure 24 to provide ink. The ink reflowing path in the second ink filling structure 24 is contrary to that in the ink filling structure 12 described above. It is noted that the principles and the actuating modes are the same to the first preferred embodiment.

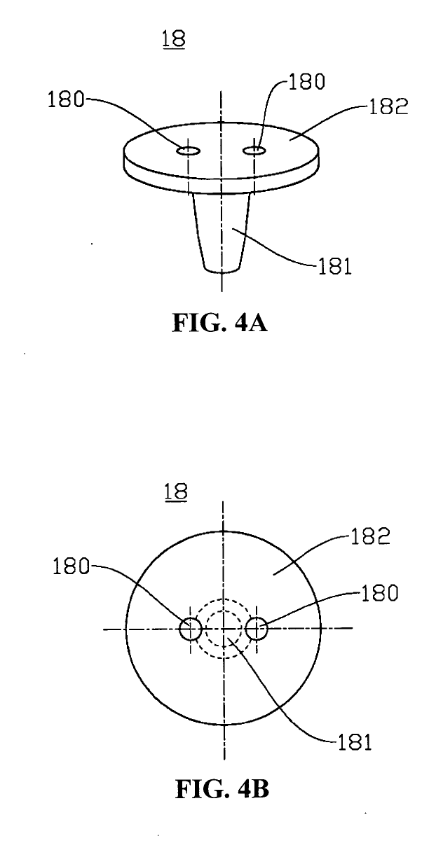

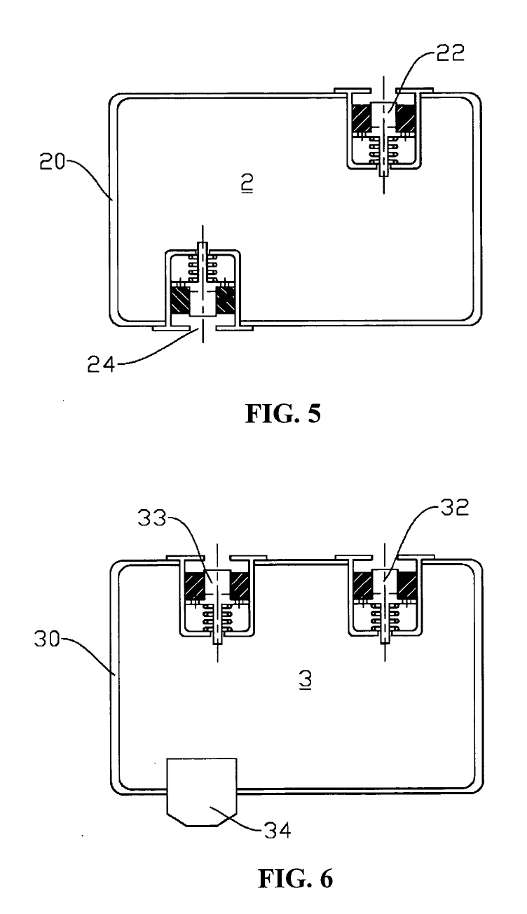

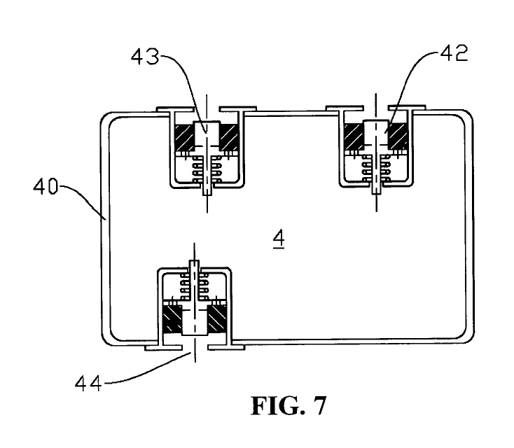

In addition, a third preferred embodiment is illustrated in FIG. 6. An ink cassette 3 includes a box 30, an ink outputting element 34, a first ink filling structure 32, and a second ink filling structure 33. Principles and actuating modes of the ink outputting element 34, the first and the second ink filling structures 32, 33 are substantially similar to those described above. Two ink filling structures are defined for providing two calibers with different diameters. Different types of ink filling containers can be accordingly used for filling ink. Further, when one ink filling structure is working, the filling process will be suffocated if there's no any more ventilate hole defined in the box 30. So, another ink filling structure is provided. A communicating member 18 is additionally provided. Referring to FIGS. 4A and 4B, the communicating member 18 includes a stopping part 182 and an extending part 181. The stopping part defines at least one ventilate hole 180 extending from the stopping part 182 to a bottom of the extending part 181. When the communicating member 18 is placed into the ink filling structure 12 from the ink inputting port 121, referring to FIG. 2C, the extending part 181 of the communicating member 18 pushes the top portion 1231 of the guiding element 123 to move toward the ink outputting port 122. The guiding element 123 is accordingly actuated to move away from the predetermined position along the extending portion 1234. Referring to FIG. 2C, as the stopping portion 1233 of the guiding element 123 is away from the washer 124, outer air can reflow via the ink inputting port 121, the guiding portion 1232, the guiding hole 1235, and the ink outputting port 122. The reflowing path is illustrated as the curves with direction arrows in FIG. 4C. Therefore, the ink can be filled into the box 30. The object of the present invention is accordingly achieved.

FIG. 7 shows a fourth embodiment. The ink cassette 4 includes a box 40, a first ink filling structure 42, a second ink filling structure 43, and a third ink filling structure 44. Principles and actuating modes of the first and second ink filling structures 42, 43 are substantially similar to those in the third embodiment. Principles and actuating modes of the third ink filling structure 44 is substantially similar to those in the second embodiment. Certainly, a corresponding printer (not shown) should be provided with a sprayer (not shown), and with a protruded guiding member to protrude into the third ink filling structure 44, which can actuate the third ink filling structure 44 to provide ink.

Based on the detailed descriptions, it is known that the present invention can assuredly provide an ink filling structure for injecting ink into an ink cassette and preventing the ink from overflowing. Further, as the ink filling structure can be directly embedded in the box of the cassette, the ink filling structure can accordingly be used in different types of ink cassettes for injecting ink into the ink cassette and preventing the ink from overflowing.

Furthermore, although the present invention has been described with reference to particular embodiment, it is not to be construed as being limited thereto. Various alterations and modifications can be made to the embodiments without in any way departing from the scope or spirit of the present invention as defined in the appended claims.

What is claimed is:

1. An ink filling structure comprising:
a case;
a guiding element received in the case for controlling reflowing of the ink;
a washer positioned between the guiding element and the case; and
an elastic element connecting with the guiding element for providing the guiding element with an elastic force to push the guiding element to a predetermined position; wherein
while the guiding element is located at the predetermined position, the guiding element prevents the ink from reflowing; while the guiding element is located at other positions, the ink can reflow.

2. The ink filling structure as claimed in claim 1, wherein the guiding element further includes a top portion, a guiding portion and a stopping portion, and when the guiding element is at the predetermined position, the stopping portion abuts against one end of the washer for preventing the ink from reflowing.

3. The ink filling structure as claimed in claim 2, wherein the guiding element further includes an extending portion, along which the guiding element can move back and forth.

4. The ink filling structure as claimed in claim 3, wherein the extending portion is sleeved by the elastic element.

5. The ink filling structure as claimed in claim 2, wherein when the top portion of the guiding element is forced, the guiding element moves away from the predetermined position, and the ink can reflow via a guiding hole defined in the guiding portion and the stopping portion.

6. The ink filling structure as claimed in claim 5, wherein the top portion of the guiding element is force by an ink filling container, by which the guiding element is actuated to leave the predetermined position, and ink in the ink filling container can reflow via the guiding hole in the guiding portion and the stopping portion.

7. The ink filling structure as claimed in claim 5, wherein the top portion is forced by a communicating member, by which the guiding element is actuated to leave the predetermined position, and outer air can reflow via a ventilative hole defined in the communicating member and the guiding holes.

8. The ink filling structure as claimed in claim 5, wherein cross-sectional shapes of the top portion and the guiding portion are same to that of an inner ring of the washer, and the cross-sectional shape of the top portion is complementary to that of the guiding portion.

9. The ink filling structure as claimed in claim 8, wherein the shape of the top portion is selected from cross, line, circle with a plurality of cuts, or complementary shapes of the above.

10. The ink filling structure as claimed in claim 1, wherein the washer abuts against an inner surface of the case, and the guiding element can move at the inner side of the washer, back and forth.

11. The ink filling structure as claimed in claim 1, wherein the elastic element is a spring or an elastic pad.

12. The ink filling structure as claimed in claim 5, wherein the guiding hole includes a filtering net therein.

13. An ink cassette comprising:
a box;
an ink outputting element located at a given position of the box for providing ink;
and a first ink filling structure located at another position of the box;
the first ink filling structure comprising:
a case;
a guiding element received in the case for controlling reflowing of the ink;
a washer positioned between the guiding element and the case;
and an elastic element connecting with the guiding element for providing the guiding element with an elastic force to push the guiding element to a predetermined position; wherein
while the guiding element is located at the predetermined position, the guiding element prevents the ink from reflowing; while the guiding element is located at other positions, the ink can reflow.

14. The ink cassette as claimed claim 13, wherein the first ink filling structure is embedded in the box.

15. The ink cassette as claimed claim 13, wherein the guiding element further includes a top portion, a guiding portion and a stopping portion, and when the guiding element is at the predetermined position, the stopping portion abuts against one end of the washer for preventing the ink from reflowing.

16. The ink cassette as claimed claim 15, wherein the guiding element further includes an extending portion, along which the guiding element can move back and forth.

17. The ink cassette as claimed claim 16, wherein the extending portion is sleeved by the elastic element.

18. The ink cassette as claimed claim 17, wherein when the top portion of the guiding element is forced, the guiding element moves away from the predetermined position, and the ink can reflow via a guiding hole defined in the guiding portion and the stopping portion.

19. The ink cassette as claimed claim 18, wherein the top portion of the guiding element is force by an ink filling container, by which the guiding element is actuated to leave the predetermined position, and ink in the ink filling container can reflow via the guiding hole in the guiding portion and the stopping portion.

20. The ink cassette as claimed claim 18, wherein the top portion is forced by a communicating member, by which the guiding element is actuated to leave the predetermined position, and outer air can reflow via a ventilative hole defined in the communicating member and the guiding holes.

21. The ink cassette as claimed claim 13, wherein cross-sectional shapes of the top portion and the guiding portion are same to that of an inner ring of the washer, and the cross-sectional shape of the top portion is complementary to that of the guiding portion.

22. The ink cassette as claimed claim 21, wherein the shape of the top portion is selected from cross, line, circle with a plurality of cuts, or complementary shapes of the above.

23. The ink cassette as claimed claim 13 further comprising a second ink filling structure, wherein the second ink filling structure is same to the first ink filling structure.

24. The ink cassette as claimed claim 13, wherein the ink outputting element is selected from the following groups: a piezoelectric sprayer, a hot-air-bubble sprayer, an ink outputting hole, a third ink filling structure.

25. The ink cassette as claimed claim 13, wherein the third ink filling structure is same to the first ink filling structure.
